(19) United States
(12) Patent Application Publication
(10) Pub. No.: US 2008/0268183 A1
(43) Pub. Date: Oct. 30, 2008

(54) RETICLE CARRIER

(76) Inventor: Ming Lung CHIU, Shulin City (TW)

Correspondence Address: SINORICA, LLC, 528 FALLSGROVE DRIVE, ROCKVILLE, MD, 20850, US

(21) Appl. No.: 11/971,277

(22) Filed: Jan. 9, 2008

(30) Foreign Application Priority Data
Apr. 27, 2007 (TW) 096206769

(51) Int. Cl. B32B 1/00

(52) U.S. Cl. 428/12

(57) ABSTRACT

A reticle carrier is disclosed in the invention, which may be combined with an inflator. The reticle carrier comprises a lid and a base; a combination of the lid and the base forms an internal space for receiving at least a reticle. The base includes a body having a plurality of through holes; each of the through holes has an inner-opening at one end and an outer opening at another end thereof; a plurality of tongues are disposed on the inner-opening of the through holes for elastically sealing the through holes. The inflator allows gases to fill into the reticle carrier via the through holes, so that the reticle carrier may be effectively cleaned by allowing gases to be filled into the reticle carrier, thus making the reticle carrier safer for storage.

### FIELD OF THE INVENTION

The present invention is related to a reticle carrier.

### DESCRIPTION OF PRIOR ART

In the making of semiconductors, reticle carriers serve as the storage device for moving and storing reticles, which isolate the reticles from the atmosphere, and prevent the surface of the reticles from becoming misty, thus protecting the reticles from external contamination. This is more important under the Standard Mechanical Interface (SMIF), which not only requires the standard of cleanness to be fulfilled, but also demands the reticles are isolated from the contamination of external gases. In addition to the atmospheric gases, there are two other sources for the external gases, one of which originates from outgasing released by the reticle carrier made of polymer materials, the other is from volatile gases generated from residual amounts of chemical solvents on the surface of the reticles. It is known that improvements in the isolation of reticles in the reticle carriers from the atmosphere may prolong the lifespan of the reticles, which in turn helps lower production cost of semiconductors and elevate the yields of semiconductors.

The conventional reticle carriers can only be used for storing reticles, and cannot be cleaned further and effectively maintain the reticles in a clean environment. As the reticles become more and more sophisticated structurally, the tolerance of reticles for contamination becomes relatively lower, and since the conventional reticle carriers may not clean the reticles, the reticles is rendered more susceptible to external contamination, which shortens the lifespan of reticles, and leads to higher production cost and hampers production.

### SUMMARY OF THE INVENTION

A primary objective of the invention is to propose a reticle carrier, which may be combined with an inflator and collectively used to prevent reticles from being damaged by external contaminants.

Another objective of the invention is to propose a reticle carrier, which uses the inflator to fill gases for cleaning a reticle stored in the reticle carrier, thus keeping the reticle in a clean environment and prolonging the lifespan of the reticle consequently.

Still another objective of the invention is to propose a reticle carrier that allows gases to fill therein, which reduces the problem of reticles becoming misty, thereby increasing the time for storing the reticles.

A further objective of the invention is to propose a reticle carrier having through holes, so as to allow gases in the inflator to be filled into the reticle carrier via the through holes, thereby enhancing the stability of the storage of the reticle carrier.

Therefore, the invention has proposed a reticle carrier that may be used in combination with an inflator, which comprises a lid and a base, a combination of the lid and the base forms an internal space for receiving at least a reticle. The base of the reticle carrier includes a body having an upper surface and a lower surface opposite to each other, and the upper and the lower surfaces have a plurality of through holes; a flexible sheet is disposed on an upper surface of the body on the base facing the lid, and the flexible sheet has a plurality of slots disposed thereon; the slots hold a plurality of tongues in correspondence to and cover each of apertures; the inflator may fill gases into the reticle carrier via the through holes. The reticle carrier comprises a plurality of sealing plugs fittingly disposed in the through holes, and each of the sealing plugs has an aperture disposed at a center thereof. An upper surface of the body of the base has a circular groove that is connected to the through holes, and each of the sealing plugs has a flange at an end thereof, which may be fitted with the circular groove and the sealing plugs become tightly combined with the through holes.

When the inflator pumps gases, the inflator penetrates the apertures inside of the sealing plugs within the through holes, and pushes aside the tongues over the apertures to allow gases to fill into the reticle carrier. On the other hand, when the inflator is pulled back or when the reticle carrier is not filled with gases, the tongues automatically return to original positions, and become tightly combined with the sealing plugs, which effectively seal the internal space of the reticle carrier from the external environment.

The reticle carrier of the invention not only allows reticles to be smoothly guided into the reticle carrier and effectively secured, but also protects the reticles from atmospheric and external contamination, thereby prolonging the lifespan of the reticles. In addition, the reticle carrier that allows gases to be filled therein may also provide an airtight space for preventing the reticles from becoming misty.

### BRIEF DESCRIPTION OF DRAWINGS

The structure and the technical means adopted by the present invention to achieve the above and other objectives can be best understood by referring to the following detailed description of the preferred embodiments and the accompanying diagrams, wherein:

FIG. 1 is a side view that shows a reticle carrier according to a preferred embodiment of the invention;

FIG. 2 is a three-dimensional view that shows a gas-filling chamber of a gas-filling apparatus in combination with the reticle carrier of the invention;

FIG. 3A is a schematic view that shows a reticle carrier according to a preferred embodiment of the invention;

FIG. 3B is a dissected view that shows through holes obtained across the B-B line in FIG. 3A;

FIG. 4A is a schematic view that shows a sealing plug according to a preferred embodiment of the invention;

FIG. 4B is a schematic view that shows a base of the reticle carrier according to a preferred embodiment of the invention;

### DETAILED DESCRIPTION OF PREFERRED EMBODIMENTS

A reticle carrier having through holes is disclosed in the invention. It should be noted that drawings mentioned in the following paragraphs are not drawn according to actual scales and sizes, and the drawings only serve the purpose of illustrating characteristics of the invention.

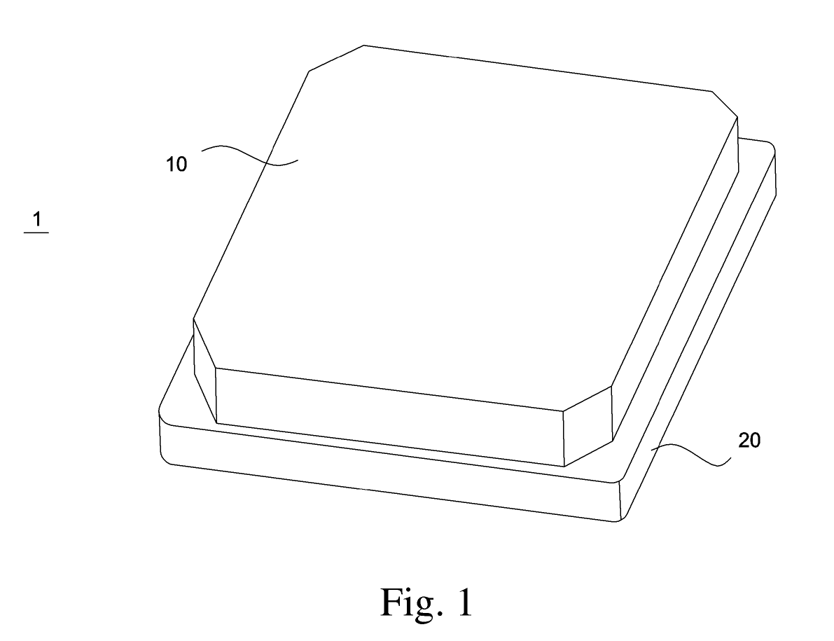

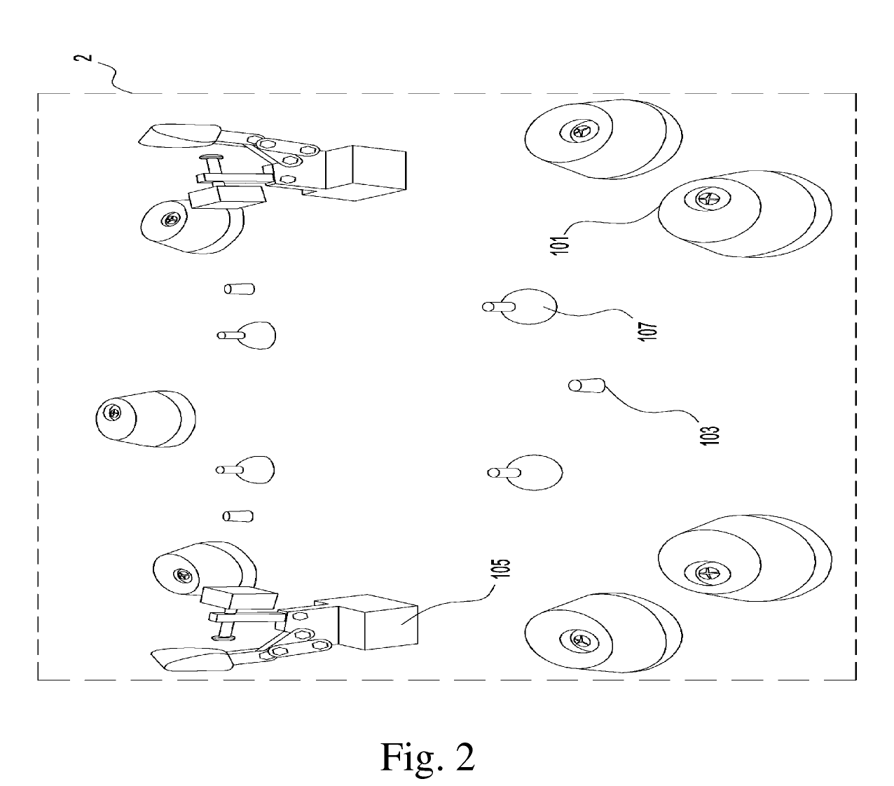

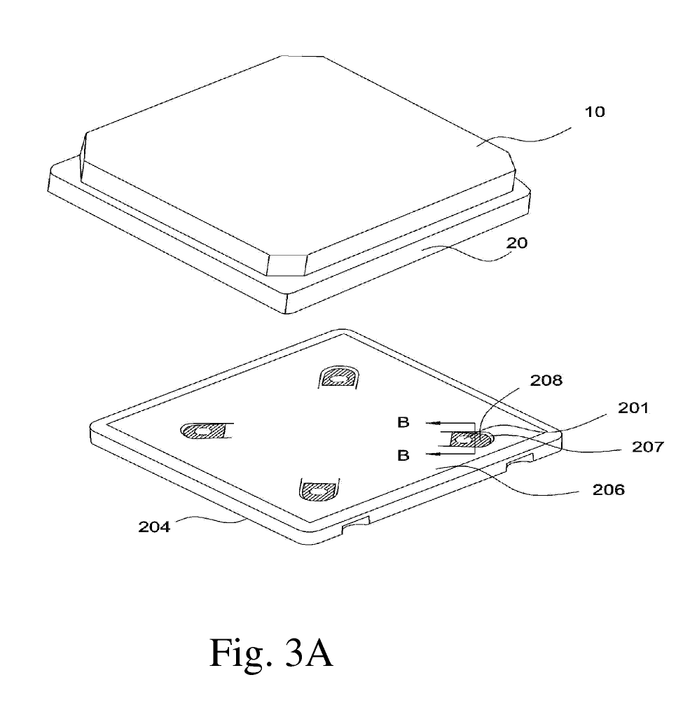

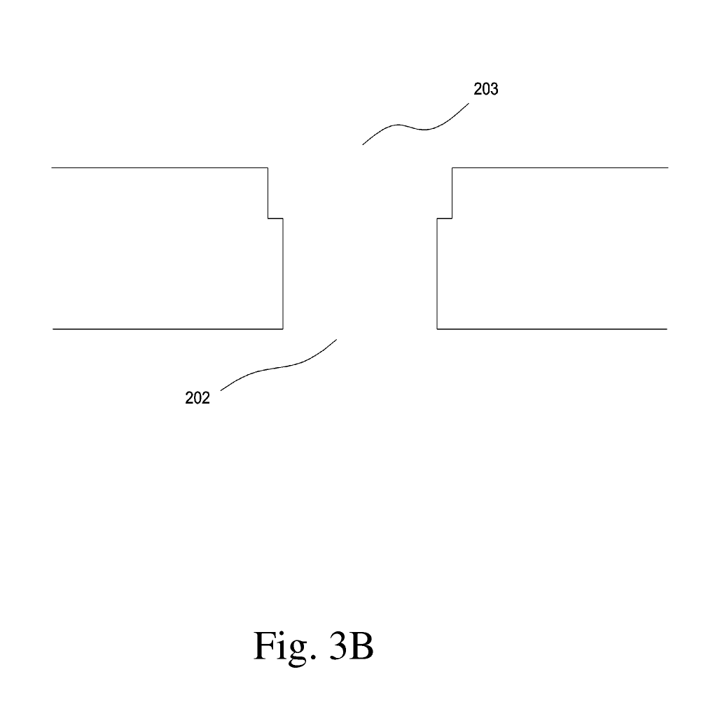

A reticle carrier that comprises through holes is disclosed in the invention; when reticles are stored and moved in the reticle carrier, an inflator may fill gases into the reticle carrier via the through holes. By filling the reticle carrier with gases, the reticles stored in the reticle carrier may be protected from contamination, thereby keeping the reticles safe from harm. Referring to FIG. 1, which shows a reticle carrier 1 according to a preferred embodiment of the invention (the reticle carrier may be used to transfer or keep reticles), the reticle carrier 1 may be combined with an external inflator 2 (as shown in FIG. 2), and the reticle carrier 1 comprises a lid 10 and a base 20; the lid 10 may be combined with the base 20 so as to form an internal space for receiving at least a reticle. When reticles are moved (between different machines, for example), the reticles are stored in the internal space of the reticle carrier 1, and the reticle carrier 1 may be combined with the inflator 2 so as to fill gases into the reticle carrier 1. Referring to FIGS. 3A and 3B, the base 20 of the reticle carrier 1 of the invention includes a body 204 having a plurality of through holes 201 thereon; each of the through holes 201 has an inner-opening 203 at one end and an outer-opening 202 at another end thereof. A flexible sheet 206 is disposed on an upper surface of the body 204 of the base 20 facing the lid 10, and the flexible sheet 206 has a plurality of slots 207 disposed thereon; the slots 207 hold a plurality of tongues 208 (as shown in FIG. 2) that are of a same quantity as the through holes 201 in correspondence to and cover each of the through holes 201 (over the inner-openings 203), and the tongues 208 may elastically seal off the through holes 201. When the reticle carrier 1 is combined with the inflator 2 to allow for pumping gases, the inflator 2 may fill gases into the reticle carrier 1 via the through holes 201 and by pushing aside the tongues 208; when the inflator 2 is pulled back and the reticle carrier 1 has not been filled with gases, the tongues 208 will automatically return to original positions.

In the preferred embodiment of the invention, the reticle carrier 1 may be made of polymer materials and plastic materials, and the flexible sheet 206 may be made of stainless steel or metals; wherein the through holes 201 comprise at least an air inlet and at least an air outlet.

Referring to FIG. 2, which shows a gas-filling chamber of the external inflator 2 in combination with the reticle carrier 1 of the invention; the chamber includes at least a first protrusion 101, a plurality of second protrusions 103, and a plurality of clamping apparatus 105, and at least a nozzle 107. Clearly, the quantity for each of the components of the gas-filling chamber should match that of the reticle carrier 1, which allows the reticle carrier 1 to be smoothly guided and placed into the gas-filling chamber of the inflator 2 for pumping and letting out gases.

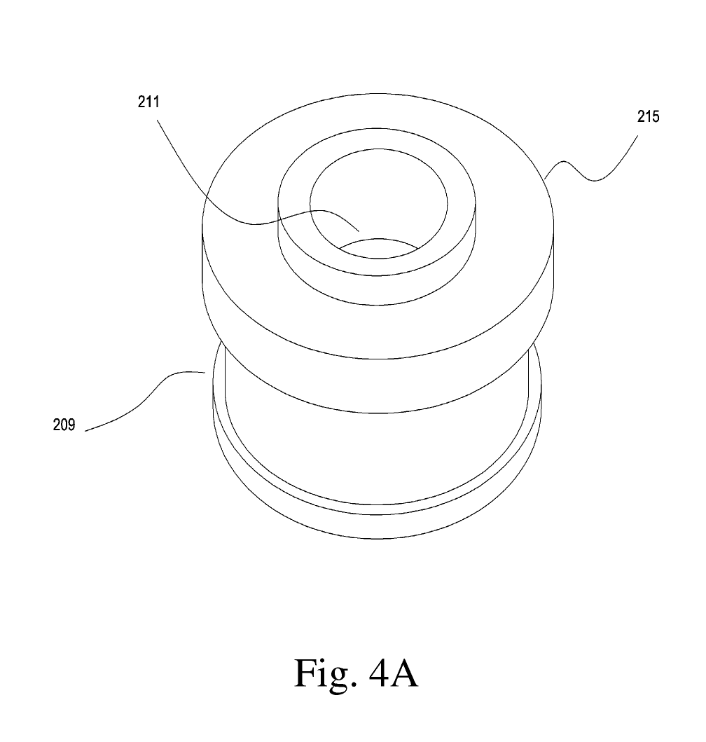

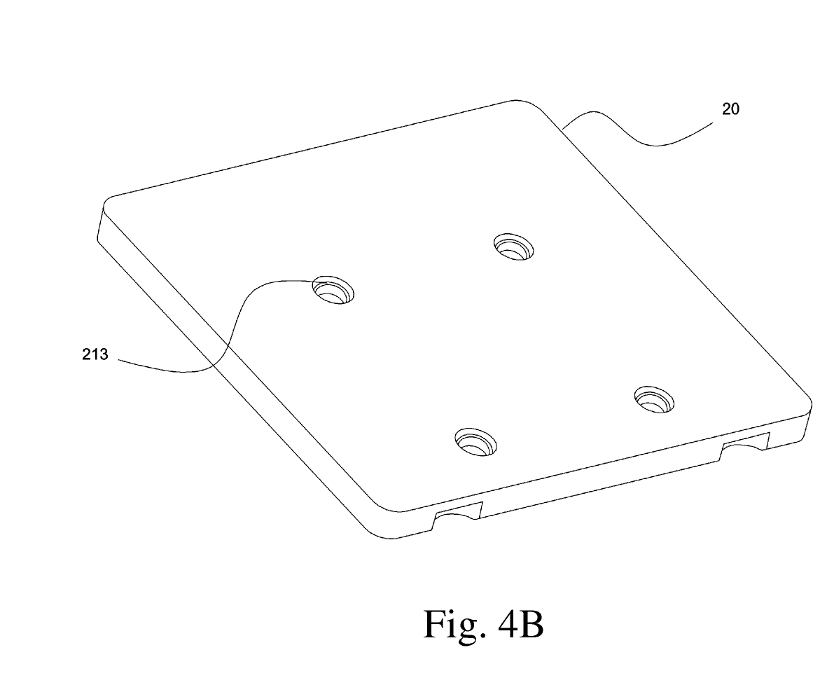

Referring to FIGS. 4A and 4B, the base 20 of the reticle carrier 1 comprises a plurality of sealing plugs 209 fittingly disposed in the through holes 201, and each of the sealing plugs 209 has an aperture 211 disposed at a center thereof. An upper surface of the body 204 of the base 20 has a circular groove 213 that is connected to the through holes 201, and each of the sealing plugs 209 has a flange 215 at an end thereof, which may be fitted with the circular groove 213 and the sealing plugs 209 become tightly combined with the through holes 201.

When the inflator 2 pumps gases, the inflator 2 penetrates the apertures 211 inside of the sealing plugs 209 within the through holes 201, and pushes aside the tongues 208 over the apertures 211 to allow gases to fill into the reticle carrier 1. On the other hand, when the inflator 2 is pulled back or when the reticle carrier 1 is not filled with gases, the tongues 208 automatically return to original positions, and become tightly combined with the sealing plugs 209, which effectively seal the internal space of the reticle carrier 1 from the external environment. The sealing plugs 209 may be made of polymer materials or plastic materials.

Although a preferred embodiment of the invention has been described for purposes of illustration, it is understood that various changes and modifications to the described embodiment can be carried out without departing from the scope and the spirit of the invention as disclosed in the appended claims.

What is claimed is:

1. A reticle carrier being combinable with an inflator; comprising
a lid; and
a base being combinable with the lid so as to form an internal space for receiving at least a reticle; the base comprises
a body having an upper surface and a lower surface opposite to each other, and the upper and the lower surfaces have a plurality of through holes disposed thereon; and
a flexible sheet being disposed on the upper surface of the body of the base facing the lid, and the flexible sheet has a plurality of slots disposed thereon; the slots hold a plurality of tongues in correspondence to and cover each of the through holes.

2. The reticle carrier of claim 1, wherein the inflator may fill gases into the reticle carrier via the through holes.

3. The reticle carrier of claim 1, wherein the lid and the base may be made of polymer materials.

4. The reticle carrier of claim 1, wherein the lid and the base may be made of plastic materials.

5. The reticle carrier of claim 1, wherein the flexible sheet may be made of metal materials.

6. The reticle carrier of claim 1, wherein the flexible sheet may be made of stainless steel.

7. The reticle carrier of claim 1, wherein the through holes comprise at least an air inlet and an air outlet.

8. The reticle carrier of claim 1, wherein the reticle carrier further comprises a plurality of sealing plugs fittingly disposed in the through holes, and each of the sealing plugs has an aperture disposed at a center thereof.

9. The reticle carrier of claim 8, wherein an upper surface of the body of the base has a circular groove that is connected to the through holes, and each of the sealing plugs has a flange at an end thereof, which may be fitted with the circular groove, and the sealing plugs become tightly combined with the through holes.

10. The reticle carrier of claim 8, wherein the sealing plugs may be made of polymer materials.

11. The reticle carrier of claim 8, wherein the sealing plugs may be made of plastic materials.
